(19) United States
(12) Patent Application Publication
(10) Pub. No.: US 2026/0017919 A1
(43) Pub. Date: Jan. 15, 2026

(54) KIN VERIFICATION OF A SUBJECT TO POTENTIAL FAMILY MEMBERS BASED ON FACIAL PHOTOS

(71) Applicant: KINSAME TECHNOLOGIES LTD., Magshimim (IL)

(72) Inventors: Tomer SAAR, Hod Hasharon (IL); Yoni DONNER, Rohnert Park, CA (US); Eitan BROWN, Hod Hasharon (IL)

(73) Assignee: KINSAME TECHNOLOGIES LTD., Magshimim (IL)

(21) Appl. No.: 19/259,499

(22) Filed: Jul. 3, 2025

Related U.S. Application Data
(60) Provisional application No. 63/669,336, filed on Jul. 10, 2024.

(51) Int. Cl. G06V 10/74; G06V 10/766; G06V 10/774; G06V 40/16

(52) U.S. Cl. CPC G06V 10/761; G06V 10/766; G06V 10/774; G06V 40/168

(57) ABSTRACT

For a given pair of biological parents and a possible child, the present system(s), method(s), and/or software estimate whether the child is indeed a biological child of the biological parents. Using a face recognition engine to determine embeddings from facial images, genetic similarity expressed in facial features is used to estimate kinship. Knowing that a child carries 50% of the genes from each parent, for example, and using facial features from both parents, chances for the present system(s), method(s), and or software to determine a correct match are increased considerably compared to prior systems.

### RELATED APPLICATION(S)

This application claims priority to and the benefit of U.S. Provisional Application No. 63/669,336, filed Jul. 10, 2024, titled “Kin Verification of a Subject to Potential Family Members Based on Facial Photos,” which is hereby incorporated by reference.

### BACKGROUND

### 1. Field

The present disclosure relates generally to kin verification of a subject to potential family members based on phenotypes/characteristics extracted from facial photos.

### 2. Description of the Related Art

The issue of missing children in the U.S. is a grave concern, with around 360,000 cases reported yearly. One significant challenge in these cases is the difficulty in identifying children who have grown up, as they often no longer resemble their childhood photos that relatives may still possess. This complicates efforts by families and law enforcement to locate them, emphasizing the need for advanced methods and continuous efforts in identifying a potentially missing child. Other techniques such as DNA tests require significant cost and effort compared to visual methods. State of the art systems are not currently able to identify such children, lost relatives, children unwillingly traveling with adults who are not relatives (e.g., kidnapped or trafficked children), or others who are similarly situated.

### SUMMARY

The following is a non-exhaustive listing of some aspects of the present techniques. These and other aspects are described in the following disclosure.

Embodiments include system(s), method(s), and/or software for identifying subjects based on correlated family relation (e.g., kinship) characteristics. Advantageously, using the present techniques, for a given pair of family members such as biological parents and a subject such as a possible child, an estimate of whether the child is indeed a biological child of the biological parents is made. Using a face recognition engine to determine embeddings from facial images, genetic similarity expressed in facial features is used to estimate kinship. Knowing that a child carries 50% of the genes from each parent, for example, and using facial features from both parents, chances for the present system(s), method(s), and or software to determine a correct match are increased considerably compared to prior systems.

The system(s), method(s), and/or software described herein estimate whether a subject (e.g., a child) is related or unrelated to two potential family members (e.g., a father and a mother, siblings) based on facial images of the subject and two potential family members, by exploiting a genetic similarity of facial features between the subject and the two potential (e.g., the father and mother, the two siblings) family members. Facial recognition embeddings are determined for each of the subject and the two potential family members based on the images.

In some embodiments, a trained machine learning model is used for estimating, based on the facial recognition embeddings, kinship for the subject and the two potential family members based on a similarity of a facial recognition embedding for the subject and facial recognition embeddings for the two potential family members. As described herein, multiple photos of each person are helpful (but not mandatory) to increase the accuracy. The embeddings of each person's photos are aggregated.

The machine learning model is trained by: generating sets of triplets, with a triplet comprising facial images of a first individual and two additional individuals who may be related to the first individual (e.g., parents) and/or each other (e.g., siblings); extracting various facial features of the first individual and the two additional individuals in the triplets to generate a facial recognition embedding for each member of the triplet; and determining similarity of embeddings for the first individual and the two additional individuals, with the similarity indicative of first and/or other degrees of kinship. First degree kinship comprises a parent, child or a sibling relationship, for example.

In some embodiments, the trained machine learning model comprises a regression model. The sets of triplets may comprise both positive triplets, where the individual is a first degree relation of the two additional individuals, and negative triplets, where the individual is unrelated to the two additional individuals.

In some embodiments, the similarity of embeddings for the first individual and the two additional individuals comprises a maximal and/or minimal cosine similarity. This is one example technique among others that may be used to determine similarity.

In some embodiments, an aggregated facial recognition embedding is determined for the two potential family members based on each individual facial recognition embedding for the two potential family members. Kinship for the subject and the two potential family members is estimated based on (1) a similarity of the facial recognition embedding for the subject and the aggregated facial recognition embedding for the two potential family members, and (2) estimated kinship output from the trained machine learning model, and/or other information. The similarity of the facial recognition embedding for the subject and the aggregated facial recognition embedding for the two potential family members, and the estimated kinship output from the trained machine learning model may be weighted relative to each other. The aggregated facial recognition embedding for the two potential family members may be an average facial recognition embedding for the two potential family members, for example. In some embodiments, the similarity of the facial recognition embedding for the subject and the aggregated facial recognition embedding for the two potential family members comprises a cosine similarity.

In some embodiments, the facial recognition embeddings for each of the subject and the two potential family members are average facial recognition embeddings.

In some embodiments, the two potential family members comprise potential biological parents of the subject, potential siblings of the subject, or a combination thereof.

In some embodiments, a facial recognition embedding collectively represents one or more phenotypes associated with various facial features of a face. An embedding may be multidimensional, with different dimensions corresponding to different phenotypes. A phenotype comprises a detectable characteristic in a facial image. Different phenotypes comprise one or more dimensions and/or locations of one or more parts of faces, an indication of age, an indication of gender, an indication of race, eye color, hair color, skin color, presence of unique skin characteristics, and/or bone structure.

In some embodiments, a trained probabilistic model is used for estimating, based on the facial recognition embeddings, kinship for the subject and the two potential family members based on a similarity of a facial recognition embedding for the subject and facial recognition embeddings for the two potential family members. The trained probabilistic model: is configured to account for a genetic relatedness between the subject and the two potential family members, with one-half of genetic variance being associated with each of the two potential family members; comprises one or more model parameters which are fit using a maximum a posteriori estimation; and is configured to output a conditional likelihood that the subject is related to the two potential family members.

In some embodiments, the one or more model parameters of the probabilistic model comprise a heritability of one or more phenotypes (e.g., as described above) associated with various facial features of a face extracted from the facial images of the subject and the two potential family members and used to determine the facial recognition embeddings. The heritability indicates a degree of variation in a phenotypic characteristic in the facial images of the subject and the two potential family members that is due to genetic variation between the facial images of the subject and the two potential family members.

In some embodiments, the system(s), method(s), and/or software described herein determine an aggregated facial recognition embedding for the two potential family members based on each individual facial recognition embedding for the two potential family members; estimate first kinship for the subject and the two potential family members based on a similarity of the facial recognition embedding for the subject and the aggregated facial recognition embedding for the two potential family members; and estimate, based on the facial recognition embeddings, with a trained machine learning model, second kinship for the subject and the two potential family members based on the similarity of the facial recognition embedding for the subject and facial recognition embeddings for the two potential family members. The machine learning model is trained by: generating sets of triplets, with a triplet comprising one or more facial images of a first individual and one or more facial images each of two additional individuals who are related to the first individual (e.g., parents) and/or each other (e.g., siblings); extracting various facial features of the first individual and the two additional individuals in the triplets to generate a facial recognition embedding for each member of the triplet; and determining similarity of embeddings for the first individual and the two additional individuals. The similarity may be indicative of first and/or other degrees of kinship. The system(s), method(s), and/or software described herein also estimate, based on the facial recognition embeddings, with a trained probabilistic model, third kinship for the subject and the two potential family members based on the similarity of the facial recognition embedding for the subject and facial recognition embeddings for the two potential family members. The trained probabilistic model: is configured to account for a genetic relatedness between the subject and the two potential family members, with one-half of genetic variance being associated with each of the two potential family members; comprises one or more model parameters which are fit using a maximum a posteriori estimation; and is configured to output a conditional likelihood that the subject is related to the two potential family members. The system(s), method(s), and/or software described herein may estimate a combined kinship for the subject and the two potential family members based on the first kinship, the second kinship, and the third kinship (which may be weighted relative to each other, for example).

In some embodiments, an estimated kinship for the subject and the two potential family members may be displayed in a user interface.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 is a logical-architecture block diagram that illustrates a system including a face recognition engine and other components as described herein configured for identifying subjects based on family relation (e.g., kinship) characteristics.

FIG. 2 is a schematic illustration of facial images of a subject and two potential family members.

FIG. 3 illustrates a facial image (e.g., an image of the subject or one of the two potential family members shown in FIG. 2) showing various facial features of a face.

FIG. 4 is a diagram that illustrates an exemplary computing system.

FIG. 5 is a flow chart that illustrates a method for facilitating recognition of a subject based on facial images of the subject and two potential family members, by exploiting a genetic similarity of facial features between the subject and the two potential family members.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the field of unknown subject identification. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

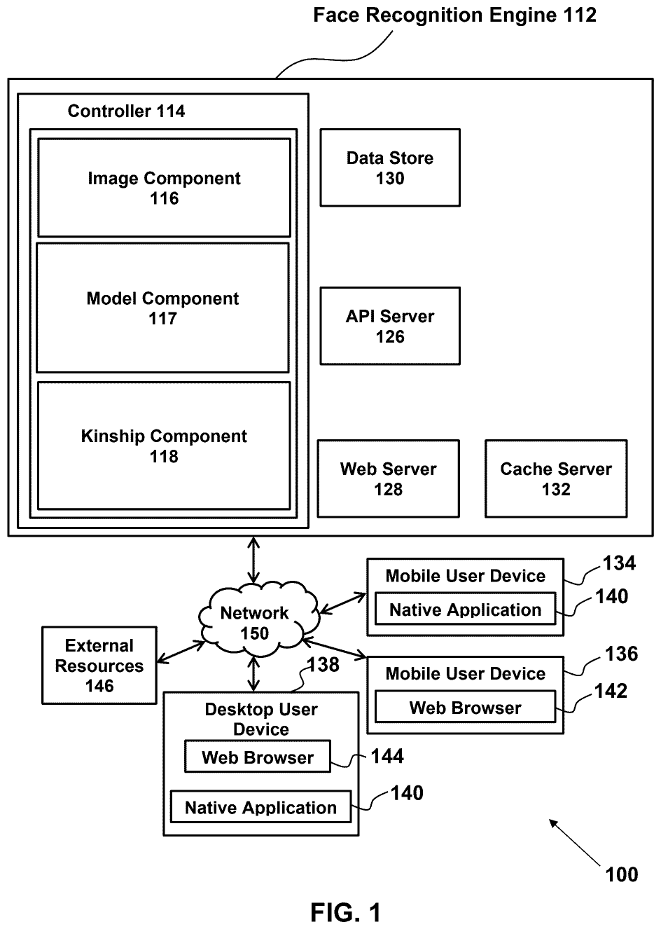

FIG. 1 illustrates a system 100 comprising a face recognition engine 112 and other components configured estimate whether a subject is related or unrelated to two potential family members based on facial images of the subject and the two potential family members, by exploiting a genetic similarity of facial features between the subject and the two potential family members. The two potential family members may comprise potential biological parents of the subject, potential siblings of the subject, or a combination thereof. The subject may comprise a missing child who may or may not be related to the potential family members, for example, and/or any other subject whose identity is unknown. The facial images of the subject and two potential family members may be a triplet. System 100 is configured to estimate, for a given pair of family members such as biological parents and a subject such as a possible child (e.g., whose images comprise a triplet), whether the child is indeed a biological child of the biological parents (or more generally whether the subject is related to the pair of family members). Using face recognition engine 112 to determine embeddings from facial images, genetic similarity expressed in facial features is used to estimate kinship. Knowing that a child carries 50% of the genes from each parent, for example, and using facial features from both parents, chances for face recognition engine 112 and system 100 to determine a correct match are increased considerably compared to prior systems.

The authors are unaware of any prior kinship estimation systems that estimate kinship between a subject (e.g., a child) and two potentially related family members (e.g., parents), that takes advantage of the direct genetic contribution of the two potentially related family members to the subject, which influences phenotype resemblance. System 100 overcomes challenges associated with determining a sufficient representation of a face as an embedding vector, since most embedders are trained to detect the same person, i.e. to make the vectors as similar as possible when given two photos of the same person, and make them different when different persons are presented. When two people are also family members, they are not the same person, but state of the art embedders are trained to consider them as false matches. System 100 changes the way an embedder works so it is trained to provide a positive answer if the two persons are related, even if they are not the same person. To explain in a more intuitive manner, a system may expect all facial features to be identical between photos if they belong to the same person. In system 100, some features can be identical (for example the nose) and some different (mouth, forehead). Or even more complex, one child can be similar to one parent, another to the other parent, and yet another does not resemble either.

These and other benefits are described in greater detail below, after introducing the components of system 100 and describing their operation. It should be noted, however, that not all embodiments necessarily provide all of the benefits outlined herein, and some embodiments may provide all or a subset of these benefits or different benefits, as various engineering and cost tradeoffs are envisioned, which is not to imply that other descriptions are limiting.

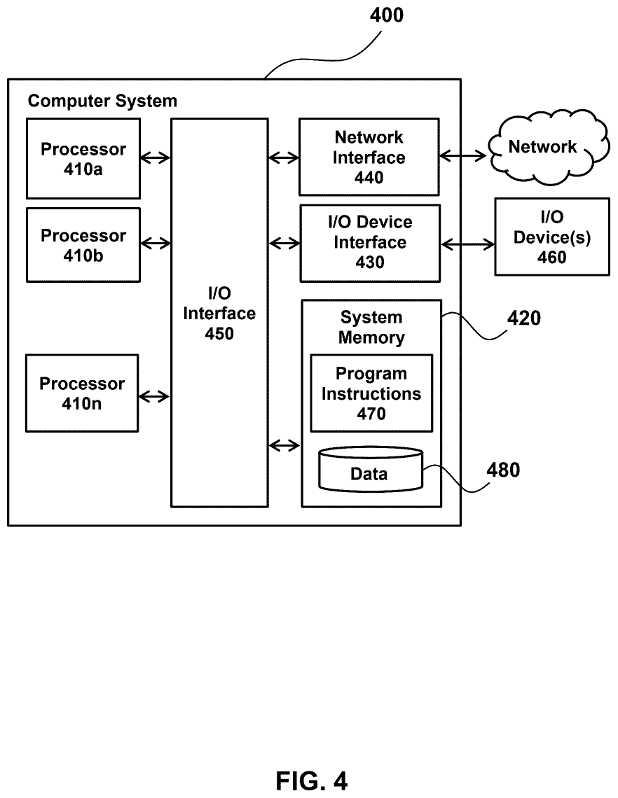

In some embodiments, face recognition engine 112 is executed by one or more of the computers described below with reference to FIG. 4 and may include one or more of a controller 114, an application program interface (API) server 126, a web server 128, a data store 130, and a cache server 132. These components, in some embodiments, communicate with one another in order to provide the functionality of face recognition engine 112 described herein. As described in greater detail below, in some embodiments, data store 130 may store and/or access data comprising one or more images and/or other data.

Cache server 132 may expedite access to this data by storing likely relevant data in relatively high-speed memory, for example, in random-access memory or a solid-state drive. Web server 128 may serve webpages having graphical user interfaces that display one or more views that facilitate recognizing the subject and/or the subject's family, displaying some and/or all of this or related information, and/or other views. API server 126 may serve data to various applications that process data related to user requested subject identifications, or other data. The operation of these components 126, 128, and 130 may be coordinated by controller 114, which may bidirectionally communicate with each of these components or direct the components to communicate with one another. Communication may occur by transmitting data between separate computing devices (e.g., via transmission control protocol/internet protocol (TCP/IP) communication over a network), by transmitting data between separate applications or processes on one computing device; or by passing values to and from functions, modules, or objects within an application or process, e.g., by reference or by value.

In some embodiments, interaction with users and/or other entities may occur via a website or a native application viewed on a smartphone, a desktop computer, a tablet, or a laptop of the user, for example. In some embodiments, such interaction occurs via a mobile application or website viewed on a smartphone, tablet, or other mobile user device, or via a special-purpose native application executing on a smartphone, tablet, or other mobile user device. Data (e.g., input images of a subject and two potential family members, etc.) may be extracted by controller 114 and/or other components of system 100 from data store 130 and/or other sources inside or outside system 100 in a secure and encrypted fashion. Data extraction by controller 114 may be configured to be sufficient for system 100 to function as described herein, without compromising privacy and/or other requirements associated with a data source. Facilitating secure subject identity determinations across a variety of devices is expected to make it easier for the users to complete identifications when and where convenient for the user, and/or have other advantageous effects.

To illustrate an example of the environment in which face recognition engine 112 operates, FIG. 1 includes a number of components with which face recognition engine 112 communicates: mobile user devices 134 and 136; a desk-top user device 138; and external resources 146. Each of these devices communicates with face recognition engine 112 via a network 150, such as the Internet or the Internet in combination with various other networks, like local area networks, cellular networks, Wi-Fi networks, or personal area networks.

Mobile user devices 134 and 136 may be smart phones, tablets, gaming devices, or other hand-held networked computing devices having a display, a user input device (e.g., buttons, keys, voice recognition, or a single or multi-touch touchscreen), memory (such as a tangible, machine-readable, non-transitory memory), a network interface, a portable energy source (e.g., a battery), and a processor (a term which, as used herein, includes one or more processors) coupled to each of these components. The memory of mobile user devices 134 and 136 may store instructions that when executed by the associated processor provide an operating system and various applications, including a web browser 142 or a native mobile application 140. The desktop user device 138 may also include a web browser 144. In addition, desktop user device 138 may include a monitor; a keyboard; a mouse; memory; a processor; and a tangible, non-transitory, machine-readable memory storing instructions that when executed by the processor provide an operating system and the web browser and/or the native application 140.

Native application 140 and web browsers 142 and 144, in some embodiments, are operative to provide a graphical user interface associated with a user, for example, which communicates with face recognition engine 112 and facilitates user interaction with data from face recognition engine 112. In some embodiments, face recognition engine 112 may be stored on and/or otherwise be executed by user computing resources (e.g., a user computer, server, etc., such as mobile user devices 134 and 136, and desktop user device 138 associated with a user), servers external to the user, and/or in other locations. In some embodiments, face recognition engine 112 may be run as an application (e.g., an app such as native application 140) on a user server, a user computer, and/or other devices.

Web browsers 142 and 144 may be configured to receive a website from face recognition engine 112 having data related to instructions (for example, instructions expressed in JavaScript™) that when executed by the browser (which is executed by the processor) cause mobile user device 136 and/or desktop user device 138 to communicate with face recognition engine 112 and facilitate user interaction with data from face recognition engine 112. Native application 140 and web browsers 142 and 144, upon rendering a webpage and/or a graphical user interface from face recognition engine 112, may generally be referred to as client applications of face recognition engine 112, which in some embodiments may be referred to as a server. Embodiments, however, are not limited to client/server architectures, and face recognition engine 112, as illustrated, may include a variety of components other than those functioning primarily as a server. Three user devices are shown, but embodiments are expected to interface with substantially more, with more than 100 concurrent sessions and serving more than 1 million users distributed over a relatively large geographic area, such as a state, the entire United States, and/or multiple countries across the world.

External resources 146, in some embodiments, include sources of information such as databases (e.g., which may store one or more images of faces, etc.), websites, etc.; external entities participating with system 100 (e.g., systems or networks associated with missing persons organizations, etc.), one or more servers outside of system 100, a network (e.g., the internet), electronic storage, equipment related to Wi-Fi™ technology, equipment related to Bluetooth® technology, data entry devices, or other resources. In some implementations, some or all of the functionality attributed herein to external resources 146 may be provided by resources included in system 100. External resources 146 may be configured to communicate with face recognition engine 112, mobile user devices 134 and 136, desktop user device 138, and/or other components of system 100 via wired and/or wireless connections, via a network (e.g., a local area network and/or the internet), via cellular technology, via Wi-Fi technology, and/or via other resources.

Thus, face recognition engine 112, in some embodiments, operates in the illustrated environment by communicating with a number of different devices and transmitting instructions to various devices to communicate with one another. The number of illustrated external resources 146, desktop user devices 138, and mobile user devices 136 and 134 is selected for explanatory purposes only, and embodiments are not limited to the specific number of any such devices illustrated by FIG. 1, which is not to imply that other descriptions are limiting.

Face recognition engine 112 may include a number of components that facilitate recognition of a subject based on facial images of the subject and two potential family members, by exploiting a genetic similarity of facial features between the subject and the two potential family members. This is performed by exploiting a similarity of phenotype characteristics of the face of the subject to those of family members. For example, the illustrated API server 126 may be configured to communicate images and/or other information via a protocol, such as a representational-state-transfer (REST)-based API protocol over hypertext transfer protocol (HTTP) or other protocols. Examples of operations that may be facilitated by the API server 126 include requests to access or retrieve images, and/or other information. API requests may identify which data is to be displayed (e.g., images, an estimated kinship, a confidence level associated with an estimation, etc.), linked, modified, added, or retrieved by specifying criteria for identifying records, such as queries for retrieving or processing information about a particular subject (e.g., an image of a subject), for example. In some embodiments, the API server 126 communicates with native application 140 of the mobile user device 134 or other components of system 100.

The illustrated web server 128 may be configured to display, link, modify, add, or retrieve portions or all of images, kinship estimations, a confidence level associated with an estimation, and/or other information encoded in a webpage (e.g. a collection of resources to be rendered by the browser and associated plug-ins, including execution of scripts, such as JavaScript™, invoked by the webpage). In some embodiments, the graphical user interface presented by the webpage may include inputs by which the user may enter or select data, such as clickable or touchable display regions or display regions for text input. For example, an image of a subject may be uploaded. Such inputs may prompt the browser to request additional data from the web server 128 or transmit data to the web server 128, and the web server 128 may respond to such requests by obtaining the requested data and returning it to the user device or acting upon the transmitted data (e.g., storing posted data or executing posted commands). In some embodiments, the requests are for a new webpage or for data upon which client-side scripts will base changes in the webpage, such as XMLHttpRequest requests for data in a serialized format, e.g. JavaScript™ object notation (JSON) or extensible markup language (XML). The web server 128 may communicate with web browsers, such as the web browser 142 or 144 executed by user devices 136 or 138. In some embodiments, the webpage is modified by the web server 128 based on the type of user device, e.g., with a mobile webpage having fewer and smaller images and a narrower width being presented to the mobile user device 136, and a larger, more content rich webpage being presented to the desk-top user device 38. An identifier of the type of user device, either mobile or non-mobile, for example, may be encoded in the request for the webpage by the web browser (e.g., as a user agent type in an HTTP header associated with a GET request), and the web server 128 may select the appropriate interface based on this embedded identifier, thereby providing an interface appropriately configured for the specific user device in use.

The illustrated data store 130, in some embodiments, stores and/or is configured to access images of subjects and/or other individuals, image galleries (e.g., for model training and/or other purposes), and/or other information. Data store 130 may include various types of data stores, including relational or non-relational databases, image collections, document collections, and/or memory images, for example. Such components may be formed in a single database, or may be stored in separate data structures. In some embodiments, data store 130 comprises electronic storage media that electronically stores information. The electronic storage media of data store 130 may include one or both of system storage that is provided integrally (i.e., substantially non-removable) with system 100 and/or other storage that is connectable (wirelessly or via a wired connection) to system 100 via, for example, a port (e.g., a USB port, a firewire port, etc.), a drive (e.g., a disk drive, etc.), a network (e.g., the Internet, etc.). Data store 130 may be (in whole or in part) a separate component within system 100, or data store 130 may be provided (in whole or in part) integrally with one or more other components of system 100 (e.g., controller 114, external resources 146, etc.). In some embodiments, data store 130 may be located in a data center (e.g., a data center associated with a user), in a server that is part of external resources 146, in a computing device 134, 136, or 138, and/or in other locations. Data store 130 may include one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), or other electronically readable storage media. Data store 130 may store software algorithms, information determined by controller 114, information received via the graphical user interface displayed on computing devices 134, 136, and/or 138, information received from external resources 146, or other information accessed by system 100 to function as described herein.

Controller 114 is configured to coordinate the operation of the other components of face recognition engine 112 to provide the functionality described herein. Controller 114 may be formed by one or more processors, for example, and/or other components. Controlled components may include one or more of an image component 116, a model component 117, a kinship component 118, and/or other components. Controller 114 may be configured to direct the operation of components 116, 117, and/or 118 by software; hardware; firmware; some combination of software, hardware, or firmware; or other mechanisms for configuring processing capabilities.

It should be appreciated that although components 116, 117, and 118 are illustrated in FIG. 1 as being co-located, one or more of components 116, 117, or 118 may be located remotely from the other components. The description of the functionality provided by the different components 116, 117, and/or 118 described below is for illustrative purposes, and is not intended to be limiting, as any of the components 116, 117, and/or 118 may provide more or less functionality than is described, which is not to imply that other descriptions are limiting. For example, one or more of components 116, 117, and/or 118 may be eliminated, and some or all of its functionality may be provided by others of the components 116, 117, and/or 118, again which is not to imply that other descriptions are limiting. As another example, controller 114 may be configured to control one or more additional components that may perform some or all of the functionality attributed below to one of the components 116, 117, and/or 118. In some embodiments, face recognition engine 112 (e.g., controller 114 in addition to cache server 132, web server 128, and/or API server 126) is executed in a single computing device, or in a plurality of computing devices in a datacenter, e.g., in a service oriented or micro-services architecture.

Image component 116 is configured to receive facial images of the subject and the two potential family members (e.g., via one or more of the components of system 100 described above). Images may be received by way of electronic upload and/or download, email, text, and/or other ways of electronically communicating an image. The two potential family members may be two of a plurality of individuals who have a known relationship to each other (e.g., husband-wife, non-married parents, sibling-sibling, etc.), and who (together) may or may not have a first degree relationship to the subject. A first degree relationship comprises an immediate family member with whom the subject may share about 50% of your genetic material (e.g., parents, children, and/or siblings). In some embodiments, the plurality of individuals comprises tens of individuals, hundreds of individuals, thousands of individuals, millions of individuals, or billions of individuals (with any number of related pairs of individuals included in this number of individuals). As described above, the two potential family members may comprise potential biological parents of the subject, potential siblings of the subject, or a combination thereof. The subject may comprise a missing child who may or may not be related to the potential family members, for example, and/or any other subject whose identity is unknown (and who may be a first degree relation of the two potential family members). A missing child is just one possible example use case. Another example use case can be identification of a child accompanied to two adults at a border control to determine whether the child is being trafficked or used to make it easier for the three of them to cross. Other examples are contemplated. Taken together, the images of the subject and the two potential family members comprise a triplet.

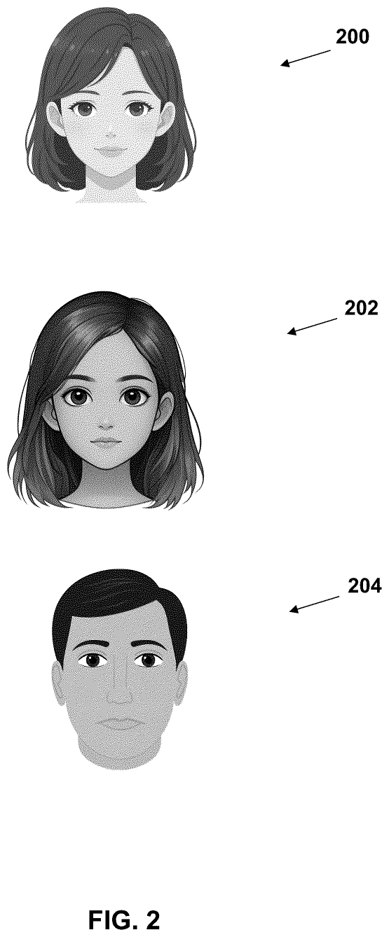

As an example, FIG. 2 shows facial images of a subject (image 200) and two potential family members (image 202 and image 204). In this example, the subject is the potential daughter of a mother and a father. The mother and father are known to be married, or at least to have had a child together at one time. As shown in FIG. 2, each image 200, 202, and 204 is of a face of one person. In some embodiments, images 200, 202, and/or 204 may be uploaded and/or downloaded to system 100 (FIG. 1), automatically obtained by image component 116 (FIG. 1) from one or more electronically accessible databases and/or other sources. For example, the database may be memory on a user's smartphone, memory in a desktop or laptop computer, a database on a server, and/or other databases. The images may be automatically obtained based on a user request, based on an image upload of an unknown subject, and/or based on other prompts.

In some embodiments, the images of the subject (image 200) and two potential family members (image 202 and image 204) may be and/or include two and/or three dimensional images, or sets of images of an individual's face and/or head. The images 200, 202, and/or 204 may be captured with still cameras, video cameras, may be generated by a model generation system, and/or may be generated by other methods. The images may include pre-labeled points of interest, reference points, linear and surface area topography, volumetric data, an indication of whether two or more of the images are from related individuals, and/or other data.

Returning to FIG. 1, image component 116 is configured to determine facial recognition embeddings for each of the subject and the two potential family members based on the images. An embedding is a (e.g., learned) transformation that converts high dimensional input data, such as an image, into a lower dimensional representation, such as a lower dimensional representation of an image. An embedding may include a number, multiple numbers, a vector, and/or other embeddings. An embedding representing a person can be an ensemble of various embeddings, some can be based on RESNET, some transformers, and some include other non-image inputs such as gender, race, age, or any other known descriptor of the person.

The facial recognition embeddings for each of the subject and the two potential family members may be average facial recognition embeddings (e.g., an average embedding configured to represent each individual) and/or some other aggregated representation. A facial recognition embedding collectively represents one or more phenotypes associated with various facial features of a face. Features of a face may include overall facial appearance, hair, head (e.g., shape, size, etc.), eyes, nose, mouth, chin, ears, cheeks, etc. An embedding may be multidimensional, with different dimensions corresponding to different phenotypes. A phenotype comprises a detectable characteristic in a facial image. The detectable characteristics may be associated with any number of different facial features (e.g., associated with a subject's overall facial appearance, hair, head, eyes, nose, mouth, chin, ears, cheeks, etc.). Different phenotypes comprise one or more dimensions and/or locations of one or more parts of faces, an indication of age, an indication of gender, an indication of race, eye color, hair color, skin color, presence of unique skin characteristics, bone structure, and/or other detectable characteristics. Note that these are just some representative examples of many more and/or different possibilities.

In some embodiments, image component 116 is configured to convert images such as images 200, 202, and 204 shown in FIG. 2 to numerical data for analysis and/or other operations (e.g., as part of generating an embedding). The data may be representative of a given phenotype (or phenotypes), determinations made based on such data (e.g., face width, length, breadth, and/or other features, information related to three dimensional facial topography data (e.g., volumetric data), two dimensional image measurements, and/or other information. In some embodiments, the numerical data may include points of interest, reference points, linear and surface area topography, volumetric data, etc., from images that has been converted to numerical values for mathematical computation and analysis, and/or other numerical data. In some embodiments, the data comprises millions of individual data points.

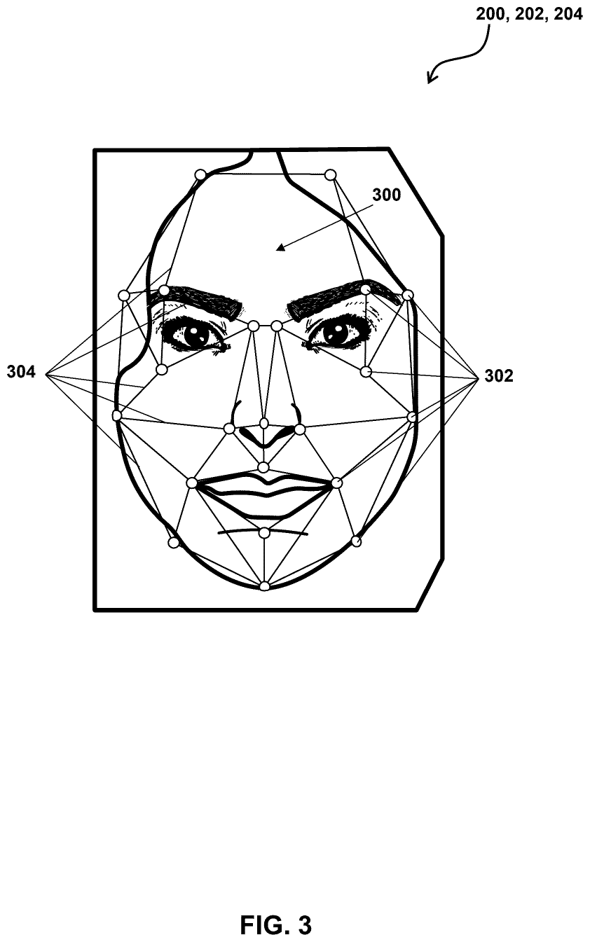

As a facial feature, phenotype, and characteristic example, FIG. 3 illustrates an image 200, 202, and/or 204 of a face 300 of an individual (e.g., either the subject or one of the two potentially related family members). In this example, various extracted facial features and/or characteristics are indicated by the dots 302 and/or lines 304 shown on face 300. In some embodiments, image component 116 (FIG. 1) may be configured to determine locations of dots 302, distances between dots 302, shapes of lines 304, and/or other information. In this example, extracted facial features and/or characteristics comprise a shape, size, location, relative location, distance between, etc., of parts (e.g., eyes, eye sockets, nose, ears, etc.) of face 300, topographical landmarks of face 300 (e.g. bridge of the nose, dimple of a chin, etc.), determinations made based on such data (e.g., face 300 appears female), full face width (see combination of lines 304 from cheek bone to cheekbone of face 300, and nose breadth (see dots 302 on either side of the nose of face 300 and the line 304 between those two dots). Again, these are just some representative examples of many more and/or different possibilities. An average facial recognition embedding may be an average of one or more of these features configured to represent each individual, and/or some other aggregated representation, for example.

Returning to FIG. 1, in some embodiments, image component 116 is configured to determine an aggregated facial recognition embedding for the two potential family members (e.g., an aggregation of image 202 (mother) and image 204 (father) from FIG. 2) based on each individual facial recognition embedding for the two potential family members, and/or other information. The aggregated facial recognition embedding for the two potential family members may be an average facial recognition embedding for the two potential family members and/or other aggregations. In some embodiments, image component 116 is configured to estimate kinship (e.g., a first kinship estimation) for the subject and the two potential family members based on a similarity of the facial recognition embedding for the subject and the aggregated facial recognition embedding for the two potential family members, and/or other information. The similarity may be a cosine similarity and/or other similarities or a machine learning neural network that accepts the embeddings and outputs a level of similarity between them. Cosine similarity may be used to determine similarity between two embeddings (e.g., such as vectors). Mathematically, cosine similarity between two embeddings such as vectors comprises the cosine of the angle between them in a multidimensional space associated with the vector. For example, image component 116 may determine an average face recognition embedding for each member of a triplet (e.g., the images of the subject and the two potential family members), determine an average embedding of both parents (e.g., an aggregated facial recognition embedding for the two potential family members), and estimate kinship based on the cosine similarity. Note that cosine similarity is just one possible way to measure how close the vectors are, among other possible methods. Similarity may be determined using an algorithm such as XGBOOST, or by classical or deep neural networks, as additional examples.

As described above, an aggregation may be a single number or multiple numbers, i.e. a vector. Such a vector is a collection of numbers representing various characteristics, for example. An aggregated representation of the face of the individual, and/or the two potential family members, comprises a general characteristic representation of the subject and/or the two potential family members. Aggregating may comprise averaging and/or other aggregation of some or all of the characteristics such as the shape, size, location, relative location, distance between, etc., determinations made based on such data, width, length, breadth (these are just examples), age, gender, race, eye color, hair color, skin color, presence of unique skin characteristics, bone structure, and/or other detectable characteristics. This may produce one aggregated measure for each characteristic, or one single aggregated measure for all characteristics, for each of the subject, and/or each set of two potential family members, for example. Aggregation is helpful, for example, if several photos are provided, because the system can eliminate blurriness or missing features due to the angle(s) of the photos or other defects. In addition, more photos can cover features if taken at different ages of the subject, for example. Further, other features such as age, gender, race, and others can be used.

Model component 117 is configured to estimate, based on the facial recognition embeddings, with a trained machine learning model, kinship (e.g., a second kinship estimation) for the subject and the two potential family members based on the similarity of the facial recognition embedding for the subject and facial recognition embeddings for the two potential family members. The machine learning model may be and/or comprise a regression model and/or other models, for example. The machine learning model is trained by generating sets of triplets. The sets of triplets may comprise both positive triplets, where the individual is a first and/or other degree relation of the two additional individuals, and negative triplets, where the individual is unrelated to the two additional individuals. A triplet comprises facial images of a first individual and two additional individuals who are related to the first individual (e.g., parents) and/or each other (e.g., siblings). The machine learning model (e.g., a classical machine learning regression model) is trained by extracting various facial features of the first individual and the two additional individuals in the triplets to generate a facial recognition embedding for each member of the triplet; and determining similarity of embeddings for the first individual and the two additional individuals (e.g., in view of labels which indicate whether a triplet is a positive or negative triplet). In some embodiments, the similarity of embeddings for the first individual and the two additional individuals comprises a maximal and/or minimal cosine similarity, and/or other similarities. The similarity is indicative of first and/or other degree kinship. As described above, first degree kinship may comprise a parent child or a sibling relationship. For example, when the two additional individuals are two parents, one has maximum similarity and the other minimum. It is theoretically possible that both similarities are equal but the odds are approximately zero. The model can use this information to recognize cases where only one parent is similar and the other not at all. So maximum will be very high and minimum very low, so it is less likely all three are related.

Once trained, the machine learning model is configured to determine and/or output an indication of whether a subject likely is (or is not) related to two potential family members (e.g., based on facial recognition embeddings for each member of a new triplet provided to the machine learning model). For example, after being trained based on a large set of positive and negative triplets, and after extracting various features and/or associated characteristics (e.g., gender, hair color, various dimensions, etc.) for face recognition embeddings for each member of an input triplet, the machine learning model may determine the maximal and/or minimal cosine similarity between the face recognition embeddings for the subject and both potential family members, and/or make other determinations.

In some embodiments, an ensemble of the machine learning model and the second kinship determination together with the first kinship determination (e.g., an embedding associated with the subject compared to an average embedding for the two potentially related family members) can be used to enhance predicted (or estimated) kinship. Using an ensemble of the machine learning model and the second kinship determination together with the first kinship determination can be used to predict kinship for any triplet with first and/or other degree kinship, such as child to parents, a first sibling to two additional siblings, or a child to a parent and a sibling. For example, the machine learning model is trained as described above to analyze a general case of first and/or other degree relationship in a triplet which makes it better for more difficult cases (for example when a child only resembles one of the parents). The first kinship determination (a comparison of a facial embedding for a subject to an aggregated embedding for two potential relatives) is better for easier cases (e.g., when a child resembles both parents, because the facial features are more similar), which is why an ensemble provides a more generalized and robust kinship determination.

In some embodiments, model component 117 is configured to estimate, based on the facial recognition embeddings, with a trained probabilistic model, kinship (e.g., a third kinship estimation) for the subject and the two potential family members based on the similarity of the facial recognition embedding for the subject and facial recognition embeddings for the two potential family members, and/or other information. In general, the probabilistic model is configured to consider the impact of randomness in predicting (or estimating) outcomes (e.g., whether or not a subject is related to the two potential family members). The probabilistic model may be Bayesian, as one possible example. Parameters in such a model may be updated based on observed data. Any background knowledge may be represented as a prior distribution. This may be combined with the observed data to form a function that describes likelihood, which can be used to generate a posterior distribution.

The trained probabilistic model is configured to account for a genetic relatedness between the subject and the two potential family members, with one-half of genetic variance being associated with each of the two potential family members. The trained probabilistic model comprises one or more model parameters which are fit using a maximum a posteriori estimation; and is configured to output a conditional likelihood that the subject is related to the two potential family members.

The one or more model parameters of the probabilistic model comprise a heritability of one or more phenotypes associated with various facial features of a face extracted from the facial images of the subject and the two potential family members and used to determine the facial recognition embeddings (e.g., as described above), and/or other parameters. The heritability indicates a degree of variation in a phenotypic characteristic in the facial images of the subject and the two potential family members that is due to genetic variation between the facial images of the subject and the two potential family members, for example.

In some embodiments, the probabilistic model may be defined as follows:

$$\overline{x} \sim 𝒩 ( μ , [ \begin{matrix}1 & 0 & \frac{{h}^{2}}{2} \\ 0 & 1 & \frac{{h}^{2}}{2} \\ \frac{{h}^{2}}{2} & \frac{{h}^{2}}{2} & 1\end{matrix} ] )$$

$${x}_{ij} \sim 𝒩 ( {\overline{x}}_{i} , {σ}^{2} ) .$$

The prior (in general a probability distribution indicating an assumption about an unknown quantity of interest) is:

$${h}^{2} ∼ β ( {α}_{{h}^{2}} , {β}_{{h}^{2}} ) .$$

The probability density function of the prior is:

$$\frac{{{x}^{α - 1} ( 1 - x )}^{β - 1}}{B ( α , β )} .$$

In these equations, x is an embedding, so that x bar is an average embedding. In this model, xij is the value of the j^{th} image of the i^{th} person, i_{1,2,3}, where 1 and 2 represent the potentially related family members (e.g., parents), and 3 represents the subject (e.g., a child). The numbers 1, 2, and 3 are the values of “i” in the equations that contain the variable “i”. So 1, 2, 3 do not appear in the equations directly, but they are the values that the variable “i” can take wherever it says “x_i” or “x_ij”, for example. Maximum a posteriori estimation may be used to fit the parameters h² and 2, for example. In this model, h² is the heritability, μ is a mean embedding value, σ² is variance of noise, and α and β are hyper parameters (values which control the machine learning process). N is the Normal distribution, also known as the Gaussian distribution. B is the beta function, a standard mathematical function.

Kinship component 118 is configured to estimate a combined kinship for the subject and the two potential family members based on the first kinship, the second kinship, the third kinship, and/or other information. The first kinship, the second kinship, and the third kinship may be weighted relative to each other, for example, such that the first kinship, the second kinship, and/or the third kinship may be more or less influential on the combined kinship estimation. In some embodiments, kinship component 118 is configured to cause display, in a user interface (e.g., see FIG. 1, and/or FIG. 4), of an estimated kinship (e.g., the first kinship, the second kinship, the third kinship, the combined kinship, and/or some combination of these estimations) for the subject and the two potential family members.

Kinship component 118 is configured to utilize an ensemble of one, two, or all three kinship estimations for a robust kinship predictor (estimator) for triplets. For example, the probabilistic model may be trained directly on embedded features of a subject and the subject's potential family members (e.g., the parents of a child), after dimension reduction using principle component analysis (PCA) and/or other methods. This configures the probabilistic model to handle difficult cases other models may not be able to handle. But as with the machine learning model described above, the probabilistic model may not be ideal in some situations. Each model described herein may be better suited to find a certain group of kinships, and these groups have a large overlap, combining all kinship estimations together provides a robust model with higher coverage compared to a single model, or an ensemble of each of any two of the described models—though each kinship estimation may be used by itself and/or in any combination.

For example, in some embodiments, kinship component 118 may be configured to estimate kinship for the subject and the two potential family members based on the first kinship, and the second kinship. In other words, estimating kinship for the subject and the two potential family members may be based on (1) a similarity of the facial recognition embedding for the subject and the aggregated facial recognition embedding for the two potential family members, and (2) estimated kinship output from the trained machine learning model (which may be weighted relative to each other and/or have other characteristics). The similarity of the facial recognition embedding for the subject and the aggregated facial recognition embedding for the two potential family members may comprise a cosine similarity and/or other similarities. As another example, kinship component 118 may be configured to estimate kinship based on the third kinship alone. Other example combinations are contemplated.

Kinship component 118 is configured such that weights are assigned and used to optimize kinship estimations. Weights for different facial features and/or characteristics may be used to optimize a particular kinship estimation (e.g., the first, second, and/or third estimations described herein). Weights for different kinship estimations may be used to optimize the overall output of an ensemble model. In some embodiments, assigning and using weights to optimize outputs comprises: assigning weights to different kinship estimations depending on the nature of a triplet (e.g., what is known or unknown about a triplet); determining separate weights for embeddings for each of the subject and two potential family members; and determining weighted aggregations of embeddings, etc. In some embodiments, assigning and using weights to optimize outputs comprises individually adjusting each weight as needed to enhance the accuracy of an output.

It should be noted that in some embodiments, face recognition engine 112 may be configured such that in the above mentioned operations of the controller 114, input from users and/or sources of information inside or outside system 100 may be processed by controller 114 through a variety of formats, including clicks, touches, uploads, downloads, etc. The illustrated components (e.g., controller 114, API server 126, web server 128, data store 130, and cache server 132) of face recognition engine 112 are depicted as discrete functional blocks, but embodiments are not limited to systems in which the functionality described herein is organized as illustrated by FIG. 1. The functionality provided by each of the components of face recognition engine 112 may be provided by software or hardware modules that are differently organized than is presently depicted, for example such software or hardware may be intermingled, broken up, distributed (e.g. within a data center or geographically), or otherwise differently organized. The functionality described herein may be provided by one or more processors of one or more computers executing code stored on a tangible, non-transitory, machine readable medium.

FIG. 4 is a diagram that illustrates an exemplary computer system 400 in accordance with embodiments of the present system. Various portions of systems and methods described herein may include or be executed on one or more computer systems the same as or similar to computer system 400. For example, face recognition engine 112, mobile user device 134, mobile user device 136, desktop user device 138, external resources 146 and/or other components of system 100 (FIG. 1) may be and/or include one more computer systems the same as or similar to computer system 400. Further, processes, modules, processor components, and/or other components of system 100 described herein may be executed by one or more processing systems similar to and/or the same as that of computer system 400.

Computer system 400 may include one or more processors (e.g., processors 410a-410n) coupled to system memory 420, an input/output I/O device interface 430, and a network interface 440 via an input/output (I/O) interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computer system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computer system 400 may be a uni-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computer system 400 may include a plurality of computing devices (e.g., distributed computer systems) to implement various processing functions.

I/O device interface 430 may provide an interface for connection of one or more I/O devices 460 to computer system 400. I/O devices may include devices that receive input (e.g., from a user) or output information (e.g., to a user)-i.e., which each may comprise a user interface. I/O devices 460 may include, for example, graphical user interface presented on displays (e.g., a touch screen or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computer system 400 through a wired or wireless connection. I/O devices 460 may be connected to computer system 400 from a remote location. I/O devices 460 located on a remote computer system, for example, may be connected to computer system 400 via a network and network interface 440.

Network interface 440 may include a network adapter that provides for connection of computer system 400 to a network. Network interface may 440 may facilitate data exchange between computer system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Software such as program instructions 470 may be executable by a processor (e.g., one or more of processors 410a-410n) to implement one or more embodiments of the present techniques. Instructions 470 may include modules and/or components (e.g., components 116, 117, and 118 shown in FIG. 1) of computer program instructions for implementing one or more techniques described herein with regard to various processing modules and/or components. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times, e.g., a copy may be created by writing program code to a first-in-first-out buffer in a network interface, where some of the instructions are pushed out of the buffer before other portions of the instructions are written to the buffer, with all of the instructions residing in memory on the buffer, just not all at the same time.

I/O interface 450 may be configured to coordinate I/O traffic between processors 410a-410n, system memory 420, network interface 440, I/O devices 460, and/or other peripheral devices. I/O interface 450 may perform protocol, timing, or other data transformations to convert data signals from one component (e.g., system memory 420) into a format suitable for use by another component (e.g., processors 410a-410n). I/O interface 450 may include support for devices attached through various types of peripheral buses, such as a variant of the Peripheral Component Interconnect (PCI) bus standard or the Universal Serial Bus (USB or USB-C) standard.

Embodiments of the techniques described herein may be implemented using a single instance of computer system 400 or multiple computer systems 400 configured to host different portions or instances of embodiments. Multiple computer systems 400 may provide for parallel or sequential processing/execution of one or more portions of the techniques described herein.

Those skilled in the art will appreciate that computer system 400 is merely illustrative and is not intended to limit the scope of the techniques described herein. Computer system 400 may include any combination of devices or software that may perform or otherwise provide for the performance of the techniques described herein. For example, computer system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a television or device connected to a television (e.g., Apple TV™), or a Global Positioning System (GPS), or the like. Computer system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 400 may be transmitted to computer system 400 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present invention may be practiced with other computer system configurations.

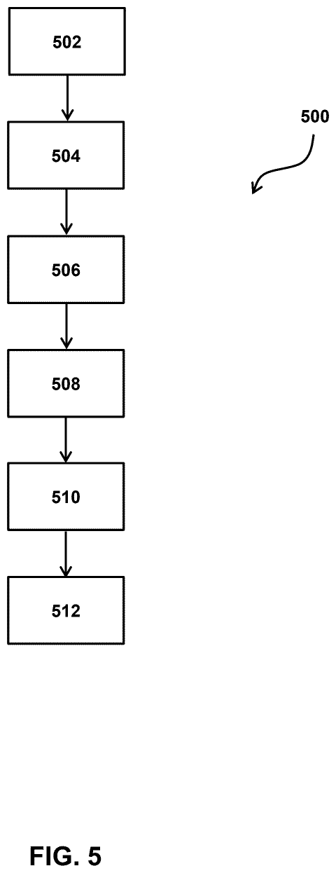

FIG. 5 is a flowchart of a method 500 for estimating whether a subject is related or unrelated to two potential family members based on facial images of the subject and the two potential family members, by exploiting a genetic similarity of facial features between the subject and the two potential family members. The two potential family members comprise potential biological parents of the subject, potential siblings of the subject, or a combination thereof. The subject may be a child, for example, who may or may not be related to the potential family members. Method 500 may be performed with some embodiments of system 100 (FIG. 1), computer system 400 (FIG. 4), and/or other components discussed above.

Method 500 includes determining (operation 502) determining facial recognition embeddings for each of the subject and the two potential family members based on the images. The facial recognition embeddings for each of the subject and the two potential family members may be average facial recognition embeddings (e.g., an average embedding configured to represent each individual) and/or some other aggregated representation. A facial recognition embedding collectively represents one or more phenotypes associated with various facial features of a face. An embedding may be multidimensional, with different dimensions corresponding to different phenotypes. A phenotype comprises a detectable characteristic in a facial image. Different phenotypes comprise one or more dimensions and/or locations of one or more parts of faces, an indication of age, an indication of gender, an indication of race, eye color, hair color, skin color, presence of unique skin characteristics, bone structure, and/or other detectable characteristics.

Method 500 includes determining (operation 504) an aggregated facial recognition embedding for the two potential family members based on each individual facial recognition embedding for the two potential family members. The aggregated facial recognition embedding for the two potential family members may be an average facial recognition embedding for the two potential family members and/or other aggregations. Method 500 includes estimating (operation 506) first kinship for the subject and the two potential family members based on a similarity of the facial recognition embedding for the subject and the aggregated facial recognition embedding for the two potential family members, and/or other information.

Method 500 includes estimating (operation 508), based on the facial recognition embeddings, with a trained machine learning model, second kinship for the subject and the two potential family members based on the similarity of the facial recognition embedding for the subject and facial recognition embeddings for the two potential family members. The machine learning model may be and/or comprise a regression model and/or other models. The machine learning model is trained by generating sets of triplets. The sets of triplets may comprise both positive triplets, where the individual is a first and/or other degree relation of the two additional individuals, and negative triplets, where the individual is unrelated to the two additional individuals. A triplet comprises facial images of a first individual and two additional individuals who are related to the first individual (e.g., parents) and/or each other (e.g., siblings). The machine learning model is trained by extracting various facial features of the first individual and the two additional individuals in the triplets to generate a facial recognition embedding for each member of the triplet; and determining similarity of embeddings for the first individual and the two additional individuals. The similarity of embeddings for the first individual and the two additional individuals comprises a maximal and/or minimal cosine similarity, and/or other similarities. The similarity is indicative of first and/or other degree kinship. First degree kinship comprises a parent child or a sibling relationship, for example.

Method 500 includes estimating (operation 510), based on the facial recognition embeddings, with a trained probabilistic model, third kinship for the subject and the two potential family members based on the similarity of the facial recognition embedding for the subject and facial recognition embeddings for the two potential family members. The trained probabilistic model is configured to account for a genetic relatedness between the subject and the two potential family members, with one-half of genetic variance being associated with each of the two potential family members. The trained probabilistic model comprises one or more model parameters which are fit using a maximum a posteriori estimation; and is configured to output a conditional likelihood that the subject is related to the two potential family members.

The one or more model parameters of the probabilistic model comprise a heritability of one or more phenotypes associated with various facial features of a face extracted from the facial images of the subject and the two potential family members and used to determine the facial recognition embeddings (e.g., as described above), and/or other parameters. The heritability indicates a degree of variation in a phenotypic characteristic in the facial images of the subject and the two potential family members that is due to genetic variation between the facial images of the subject and the two potential family members, for example.

Method 500 includes estimating (operation 512) a combined kinship for the subject and the two potential family members based on the first kinship, the second kinship, the third kinship, and/or other operations. The first kinship, the second kinship, and the third kinship may be weighted relative to each other, for example, such that the first kinship, the second kinship, and/or the third kinship may be more or less influential on the combined kinship estimation. In some embodiments, operation 512 includes causing display, in a user interface, of an estimated kinship (e.g., the combined kinship determined at operation 512) for the subject and the two potential family members.

Method 500 may include additional operations that are not described, and/or may not include one or more of the operations described. The operations of method 500 may be performed in any order and/or in any combination that facilitates high confidence kinship estimations, as described herein. For example, in some embodiments, method 500 may include operations 502- 508, with a (operation 512 equivalent) combined kinship estimation for the subject and the two potential family members based on the first kinship, and the second kinship. In other words, estimating kinship for the subject and the two potential family members may be based on (1) a similarity of the facial recognition embedding for the subject and the aggregated facial recognition embedding for the two potential family members, and (2) estimated kinship output from the trained machine learning model (which may be weighted relative to each other and/or have other characteristics). The similarity of the facial recognition embedding for the subject and the aggregated facial recognition embedding for the two potential family members may comprise a cosine similarity and/or other similarities. As another example, operation 508 may be performed before operations 506 and/or 504. As yet another example, method 500 may only include operation 508 and/or operation 510.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

1. A non-transitory computer readable medium having instructions thereon, the instructions when executed by a computer, causing the computer to estimate whether a subject is related or unrelated to two potential family members based on facial images of the subject and the two potential family members, by exploiting a genetic similarity of facial features between the subject and the two potential family members, the instructions causing operations comprising:
determining facial recognition embeddings for each of the subject and the two potential family members based on the images; and
estimating, based on the facial recognition embeddings, with a trained machine learning model, kinship for the subject and the two potential family members based on a similarity of a facial recognition embedding for the subject and facial recognition embeddings for the two potential family members, the machine learning model trained by:
generating sets of triplets, a triplet comprising facial images of a first individual and two additional individuals who are related to the first individual and/or each other;
extracting various facial features of the first individual and the two additional individuals in the triplets to generate a facial recognition embedding for each member of the triplet; and
determining similarity of embeddings for the first individual and the two additional individuals, the similarity indicative of first degree kinship.

2. The medium of claim 1, wherein first degree kinship comprises a parent child or a sibling relationship.

3. The medium of claim 1, wherein the trained machine learning model comprises a regression model.

4. The medium of claim 1, wherein the sets of triplets comprise both positive triplets, where the individual is a first degree relation of the two additional individuals, and negative triplets, where the individual is unrelated to the two additional individuals.

5. The medium of claim 1, wherein the similarity of embeddings for the first individual and the two additional individuals comprises a maximal and/or minimal cosine similarity.

6. The medium of claim 1, the operations further comprising:
determining an aggregated facial recognition embedding for the two potential family members based on each individual facial recognition embedding for the two potential family members; and
estimating kinship for the subject and the two potential family members based on (1) a similarity of the facial recognition embedding for the subject and the aggregated facial recognition embedding for the two potential family members, and (2) estimated kinship output from the trained machine learning model.

7. The medium of claim 6, wherein the similarity of the facial recognition embedding for the subject and the aggregated facial recognition embedding for the two potential family members, and the estimated kinship output from the trained machine learning model are weighted relative to each other.

8. The medium of claim 6, wherein the aggregated facial recognition embedding for the two potential family members is an average facial recognition embedding for the two potential family members.

9. The medium of claim 6, wherein the similarity of the facial recognition embedding for the subject and the aggregated facial recognition embedding for the two potential family members comprises a cosine similarity.

10. The medium of claim 1, wherein the facial recognition embeddings for each of the subject and the two potential family members are average facial recognition embeddings.

11. The medium of claim 1, wherein the two potential family members comprise potential biological parents of the subject, potential siblings of the subject, or a combination thereof.

12. The medium of claim 1, the operations further comprising causing display, in a user interface, of an estimated kinship for the subject and the two potential family members.

13. The medium of claim 1, wherein a facial recognition embedding collectively represents one or more phenotypes associated with various facial features of a face, and wherein an embedding is multidimensional, with different dimensions corresponding to different phenotypes.

14. The medium of claim 13, wherein a phenotype comprises a detectable characteristic in a facial image, and wherein different phenotypes comprise one or more dimensions and/or locations of one or more parts of faces, an indication of age, an indication of gender, an indication of race, eye color, hair color, skin color, presence of unique skin characteristics, and/or bone structure.

15. A non-transitory computer readable medium having instructions thereon, the instructions when executed by a computer, causing the computer to estimate whether a subject is related or unrelated to two potential family members based on facial images of the subject and the two potential family members, by exploiting a genetic similarity of facial features between the subject and the two potential family members, the instructions causing operations comprising:
determining facial recognition embeddings for each of the subject and the two potential family members based on the images; and
estimating, based on the facial recognition embeddings, with a trained probabilistic model, kinship for the subject and the two potential family members based on a similarity of a facial recognition embedding for the subject and facial recognition embeddings for the two potential family members, wherein the trained probabilistic model:
is configured to account for a genetic relatedness between the subject and the two potential family members, with one-half of genetic variance being associated with each of the two potential family members;
comprises one or more model parameters which are fit using a maximum a posteriori estimation; and
is configured to output a conditional likelihood that the subject is related to the two potential family members.

16. The medium of claim 15, wherein the one or more model parameters of the probabilistic model comprise a heritability of one or more phenotypes associated with various facial features of a face extracted from the facial images of the subject and the two potential family members and used to determine the facial recognition embeddings.

17. The medium of claim 16, wherein a phenotype comprises a detectable characteristic in a facial image, and wherein different phenotypes comprise one or more dimensions and/or locations of one or more parts of faces, an indication of age, an indication of gender, an indication of race, eye color, hair color, skin color, presence of unique skin characteristics, and/or bone structure.

18. The medium of claim 16, wherein the heritability indicates a degree of variation in a phenotypic characteristic in the facial images of the subject and the two potential family members that is due to genetic variation between the facial images of the subject and the two potential family members.

19. A non-transitory computer readable medium having instructions thereon, the instructions when executed by a computer, causing the computer to estimate whether a subject is related or unrelated to two potential family members based on facial images of the subject and the two potential family members, by exploiting a genetic similarity of facial features between the subject and the two potential family members, the instructions causing operations comprising:
determining facial recognition embeddings for each of the subject and the two potential family members based on the images;
determining an aggregated facial recognition embedding for the two potential family members based on each individual facial recognition embedding for the two potential family members;
estimating first kinship for the subject and the two potential family members based on a similarity of the facial recognition embedding for the subject and the aggregated facial recognition embedding for the two potential family members;
estimating, based on the facial recognition embeddings, with a trained machine learning model, second kinship for the subject and the two potential family members based on the similarity of the facial recognition embedding for the subject and facial recognition embeddings for the two potential family members, the machine learning model trained by:
generating sets of triplets, a triplet comprising facial images of a first individual and two additional individuals who are related to the first individual and/or each other;
extracting various facial features of the first individual and the two additional individuals in the triplets to generate a facial recognition embedding for each member of the triplet; and
determining similarity of embeddings for the first individual and the two additional individuals, the similarity indicative of first degree kinship;
estimating, based on the facial recognition embeddings, with a trained probabilistic model, third kinship for the subject and the two potential family members based on the similarity of the facial recognition embedding for the subject and facial recognition embeddings for the two potential family members, wherein the trained probabilistic model:
is configured to account for a genetic relatedness between the subject and the two potential family members, with one-half of genetic variance being associated with each of the two potential family members;
comprises one or more model parameters which are fit using a maximum a posteriori estimation; and
is configured to output a conditional likelihood that the subject is related to the two potential family members; and
estimating a combined kinship for the subject and the two potential family members based on the first kinship, the second kinship, and the third kinship.

20. The medium of claim 19, wherein the first kinship, the second kinship, and the third kinship are weighted relative to each other.

21-40. (canceled)
